(19) United States
(12) Patent Application Publication
(10) Pub. No.: US 2009/0000345 A1
(43) Pub. Date: Jan. 1, 2009

(54) Manufacturing Method, System and Apparatus for Producing a Molding System Component

(75) Inventor: Robert Dietrich SCHAD, North York (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/770,102

(22) Filed: Jun. 28, 2007

(51) Int. Cl. B29C 35/08; B21D 37/16

(52) U.S. Cl. 72/342.5; 264/402; 425/135; 425/436 R; 425/445

(57) ABSTRACT

There is disclosed a system, method and apparatus for producing a molding system component. A method for manufacturing a molding system component having a tubular configuration, at least in part, the molding system component for use with a molding system, is provided. The method comprises disposing a metallic work piece heated to a re-moldable state within a female cavity; impacting the heated metallic work piece with a male mandrel to form the molding system component between the female cavity and the male mandrel, at least partially; cooling the so-formed molding system component.

### FIELD OF THE INVENTION

The present invention generally relates to, but is not limited to, molding systems, and more specifically the present invention relates to, but is not limited to, a manufacturing method, system and apparatus for producing a molding system component.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethylene terephthalate (PET) material is a preform that is capable of being subsequently blown into a beverage container, such as, a bottle and the like.

With reference to FIG. 1, a typical injection molding systems comprises numerous components. Briefly, a molding system 100 comprises an injection molding system for processing molding material, such as, PET for example. The molding system 100 comprises a fixed platen 102 and a movable platen 104. The molding system 100 further comprises an injection unit 106 for plasticizing and injection of molding material. In operation, the movable platen 104 is moved towards and away from the fixed platen 102 by means of stroke cylinders (not shown) or any other suitable means. Clamp force (also referred to as closure or mold closure tonnage) can be developed within the molding system 100, for example, by using tie bars 108, 110 and a tie-bar clamping mechanism 112, as well as (typically) an associated hydraulic system (not depicted) that is usually associated with the tie-bar clamping mechanism 112. It will be appreciated that clamp tonnage can be generated using alternative means, such as, for example, using a toggle-clamp arrangement (not depicted) or the like.

A first mold half 114 can be associated with the fixed platen 102 and a second mold half 116 can be associated with the movable platen 104. In the specific non-limiting embodiment of FIG. 1, the first mold half 114 comprises one or more mold cavities 118. As will be appreciated by those of skill in the art, the one or more mold cavities 118 may be formed by using suitable mold inserts or any other suitable means. As such, the first mold half 114 can be generally thought of as a “mold cavity half”. The second mold half 116 comprises one or more mold cores 120 complementary to the one or more mold cavities 118. As will be appreciated by those of skill in the art, the one or more mold cores 120 may be formed by using suitable mold inserts or any other suitable means. As such, the second mold half 116 can be generally thought of as a “mold core half”.

The first mold half 114 can be coupled to the fixed platen 102 by any suitable means, such as a suitable fastener (not depicted) or the like. The second mold half 116 can be coupled to the movable platen 104 by any suitable means, such as a suitable fastener (not depicted) or the like. It should be understood that in an alternative non-limiting embodiment of the present invention, the position of the first mold half 114 and the second mold half 116 can be reversed and, as such, the first mold half 114 can be associated with the movable platen 104 and the second mold half 116 can be associated with the fixed platen 102.

FIG. 1 depicts the first mold half 114 and the second mold half 116 in a so-called “mold open position” where the movable platen 104 is positioned generally away from the fixed platen 102 and, accordingly, the first mold half 114 is positioned generally away from the second mold half 116. For example, in the mold open position, a molded article (not depicted) can be removed from the first mold half 114 and/or the second mold half 116. In a so-called “mold closed position” (not depicted), the first mold half 114 and the second mold half 116 are urged together (by means of movement of the movable platen 104 towards the fixed platen 102) and cooperate to define (at least in part) a molding cavity (not depicted) into which the molten plastic (or other suitable molding material) can be injected, as is known to those of skill in the art. It should be appreciated that one of the first mold half 114 and the second mold half 116 can be associated with a number of additional mold elements, such as for example, split inserts (commonly referred to as “neck rings”) for forming, for example, a neck area of a molded article. Furthermore, the first mold half 114 and the second mold half 116 may be associated with one or more leader pins (not depicted) and one or more leader bushings (not depicted), the one or more leader pins cooperating with one more leader bushings to assist in alignment of the first mold half 114 with the second mold half 116 in the mold closed position, as is known to those of skill in the art.

The molding system 100 may further comprise a robot 122. Generally speaking, the robot 122 can be used for molded article removing and/or post-mold cooling jointly referred to as post mold operations). The robot 122 can comprise an actuating portion 124, an actuating arm 125 and an End Of Arm Tool 126 (referred herein below for simplicity as EOAT 126). The actuating portion 124 is coupled to the fixed platen 102 by means of a suitable fastener (not depicted). Generally speaking, the actuating portion 124 is configured to be coupled to a controller (not depicted) of the molding system 100 to implement, at least partially under the control of the controller (not depicted), one or more routines. Examples of such routines include, but are not limited to, moving the EOAT 126 into an open space defined between the first mold half 114 and the second mold half 116 in the mold open position, causing the EOAT 126 to receive the molded article from the one or more mold cores 120, moving the EOAT 126 away from the open space defined between the first mold half 114 and the second mold half 116 in the mold open position, etc.

Naturally, the molding system 100 may comprise a number of additional components, such as a hot runner (not depicted) associated, for example, with the fixed platen 102 and a stripper assembly for implementing (at least in part) ejection of the molded articles. Furthermore, the molding system 100 may optionally or additionally comprise auxiliary equipment (not depicted), such as humidifiers, heaters and the like. All this equipment is known to those of skill in the art and, as such, will not be discussed at any length here.

As is well recognized in the art, the molding system 100 is a complex assembly of various components and sub-components. Manufacturing costs associated with producing the molding system 100 are quite high. Examples of such a component include various tubular-shaped components of the molding system 100, such as, for example, a nozzle housing for a hot runner, a cooling tube for the EOAT 126, a mold cavity insert body that constitutes to at least a portion of the one or more mold cavities 118 and the like. For example, traditional manufacturing process for producing the nozzle housing for the hot runner involves precise machining of the component from a block of suitable material, such as steel and the like. This process may involve numerous steps, including machining, grinding, polishing and the like. Some of these steps require specialized and/or expensive machinery, as well as highly skilled and specialized operators to operate such equipment. Some of the current processes may also result in an unnecessary waste of materials. Overall, it can be said that known processes are costly in terms of special tooling, fixtures and man power.

U.S. Pat. No. 6,230,539 issued on May 15, 2001 to Dickson et al. discloses an ultra precision net shape forming process is disclosed which can satisfy the requirements of precision millimeter wave (MMW) and sub-MMW components and sabots for small caliber armor piercing ammunition. The process is well suited to both moderate and high volume applications, and offers the potential for dramatically reducing piece part fabrication costs. The process involves closely controlled high temperature compression forming of metals with cycle times of the order of one minute or less, precise replication of all die features, and very low residual stresses. The ultra precision net shape forming cycle starts following insertion of the billet/blank into an open die. In the preheat phase the press is closed to preheat position where the billet/blank is enclosed in both halves of the die but no force is applied. Following preheat the part is formed employing displacement and force control to insure a fully formed part. After holding for a preset time at the peak force, the press is then commanded back to the loading position. The process has many of the attributes of conventional compression molding of plastics and is well suited to high volume, automated production of complex precision parts.

U.S. Pat. No. 7,004,004 issued on Feb. 28, 2006 to Arns et al. discloses a hardened steel part of complex shape that is made from a work piece by first heating the work piece to an annealing temperature. Then, while the work piece is still at the annealing temperature, the work piece is rapidly deformed by a machine into an intermediate shape. The deformed work piece is then moved from the machine to a press, and, while the work piece is still at the annealing temperature, it is deformed in the press to the complex shape and then held in the press to harden the work piece.

U.S. Pat. No. 5,214,948 issued on Jun. 1, 1993 to Sanders et al. discloses a method for forming metal parts from superplastic metal alloys uses axial compression of the blank starting material. A blank of the superplastic metal alloy is enclosed within a die press. The blank is generally tubular, although not necessarily circular, and has an aperture at each end. The ends of the blank are enclosed within correspondingly shaped sections of a cavity within the die press, while the center of the blank is disposed within a central cavity defining a desired shape of the metal part to be formed. Each end of the blank is then sealed with a ram or stop member, and the die press and blank are heated to a forming temperature that is within the superplastic temperature range of the metal alloy. Gas is supplied under pressure to the inside of the blank to produce an outward pressure urging the blank to deform outwardly within the central cavity of the die press. The blank is simultaneously compressed axially with one or both of the rams or stops, to cause additional superplastic metal alloy to be supplied to the central cavity as the blank undergoes superplastic flowing, so that thinning of the blank is limited during the formation of the part. The pressures inducing the superplastic flowing and the rate of axial compression can be varied in different combinations to produce parts with a wide range of shapes and thicknesses. These procedures are preferably performed under preprogrammed direction by a computer to attain precise control and repeatability.

### SUMMARY OF THE INVENTION

According to a first broad aspect of the present invention, there is provided a method for manufacturing a molding system component having a tubular configuration, at least in part, the molding system component for use with a molding system. The method comprises disposing a metallic work piece heated to a re-moldable state within a female cavity; impacting the heated metallic work piece with a male mandrel to form the molding system component between the female cavity and the male mandrel, at least partially; cooling the so-formed molding system component.

According to a second broad aspect of the present invention, there is provided a system for manufacturing a molding system component having a tubular configuration, at least in part, the molding system component for use with a molding system. The system comprises a heating station configured to heat a metallic work piece to a re-moldable state; a forming station configured to impact the heated metallic work piece with a male mandrel to form the molding system component between the female cavity and the male mandrel, at least partially.

According to a third broad aspect of the present invention, there is provided an apparatus for manufacturing a molding system component having a tubular configuration, at least in part, the molding system component for use with a molding system. The apparatus comprises means for heating a metallic work piece to a re-moldable state; means for impacting the metallic work piece to form the molding system component; means for cooling the so-formed molding system component.

A technical effect, amongst others, of the aspects of the present invention may include reduced manufacturing costs attributable at least in part to a lack of or reduced requirement for precise machining. Another technical effect of the aspects of the present invention may include a more effective manufacturing process or, in other words, a process that is faster and/or requires fewer man-hours. It should be expressly understood that not all of the technical effects, in their entirety, need be realized in each and every embodiments of the present invention.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 is a schematic view of a typical molding system 100;

FIG. 2 is a schematic representation of a manufacturing system 200, according to a non-limiting embodiment of the present invention, which can be used for producing a molding system component for use with the molding system 100 of FIG. 1.

FIG. 3 is a schematic representation of a forming station 206 of the manufacturing system 200 of FIG. 2.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### Detailed Description of Embodiments

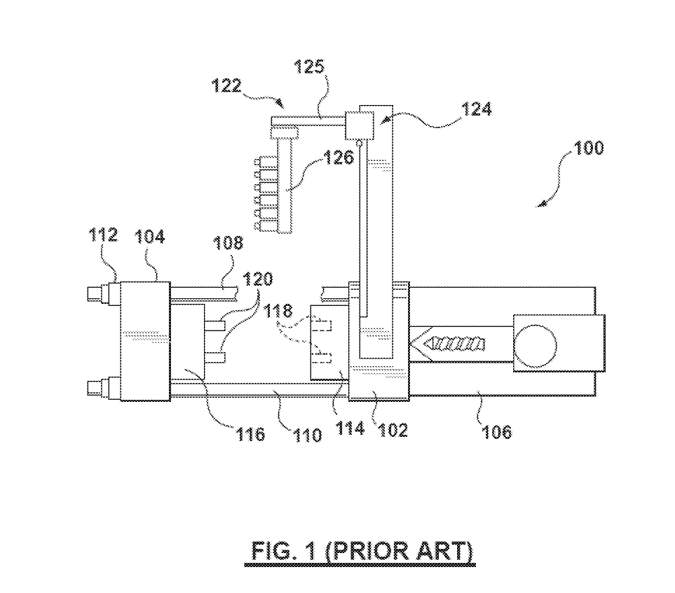

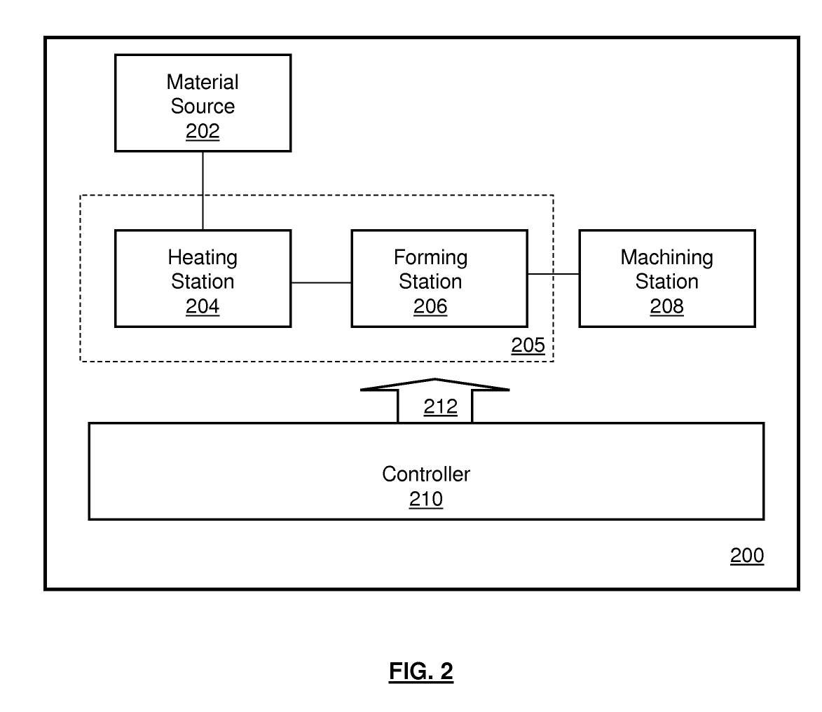

With reference to FIG. 2, a non-limiting embodiment of a system for producing a molding system component will now be described in greater detail. A system for producing a molding system component is schematically depicted in FIG. 2 at 200 and will be referred to herein below, for the sake of simplicity, as a “manufacturing system 200”. The manufacturing system 200 can be used for producing various at least partially tubular components for molding systems, such as the molding system 100 of FIG. 1, for example. Some examples of the components that can be produced using the manufacturing system 200 include, but are not limited to, a nozzle assembly for a hot runner of the molding system 100 of FIG. 1, a tubular body of a molded part receptacle (ex. a cooling tube) for the EOAT 126 of the molding system 100 of FIG. 1, a mold cavity insert body and the like. For the avoidance of doubt, it should be expressly understood that embodiments of the present invention can be used to produced various at least partially tubular components for a molding system, such as the molding system 100 of FIG. 1 or other similar systems (such as, a metal molding system and the like).

The manufacturing system 200 comprises a material source 202, which maintains raw material to be used within the manufacturing system 200. In some embodiments of the present invention, the material source 202 maintains supply of steel (for example, a supply of tool steel), etc. In other embodiments of the present invention, the material source 202 can maintain supply of any suitable raw material, such as other metals or alloys, as will be appreciated by those of skill in the art.

The manufacturing system 200 further comprises a heating station 204, operatively coupled to the material source 202. In some embodiments of the present invention, the heating station 204 may be coupled to the material source 202 by means of a conveyor belt or any other suitable means for transporting raw material from the material source 202 to the heating station 204. In alternative non-limiting embodiments of the present invention, the heating station 204 and the material source 202 do not have to be interconnected by a physical link. Within these embodiments of the present invention, an operator managing the heating station 204 can manually transport raw material between the material source 202 and the heating station 204. Generally speaking, the purpose of the heating station 204 is to heat raw material to a re-moldable state. Within this context, raw material being treated in the heating station 204 can be referred to as a “metallic work piece”.

The exact temperature to which the raw material has to be heated is not particularly limited and, naturally, will depend on the type of raw material being used. It is anticipated that selection of the required temperature is within grasps of those of skill in the art. Within a specific non-limiting embodiment of the present invention, the heating station 204 can be implemented as a conventional furnace. Alternatively, the heating station 204 can be implemented as an infra-red heating based device, induction heating based device or utilizing any other suitable type of heating means.

The manufacturing system 200 further comprises a forming station 206, operatively coupled to the heating station 204. In some embodiments of the present invention, the forming station 206 may be coupled to the heating station 204 by means of a conveyor belt or any other suitable means for transporting molten raw material from the heating station 204 to the forming station 206. In alternative non-limiting embodiments of the present invention, the forming station 206 and the heating station 204 do not have to be connected by a physical link. Within these embodiments of the present invention, an operator managing the forming station 206 can manually transport molten raw material between the heating station 204 and the forming station 206 appropriate tooling. The structure of the forming station 206 will be described in greater detail momentarily; however, for the time being suffice it to say that the purpose of the forming station 206 is to accept the molten raw material and to form an article (ex. a molding system component). Within this context, raw material being treated in the forming station 206 can be referred to as a “heated metallic work piece” or a “work piece that has been heated to a re-moldable state”.

Within the embodiments being presented above, the heating station 204 and the forming station 206 have been described as physically distinct entities. However, in an alternative non-limiting embodiment of the present invention, the heating station 204 and the forming station 206 can form part of a single device 205 used for both heating of the raw material and forming the article from the so-heated raw material (ex. a molding system component).

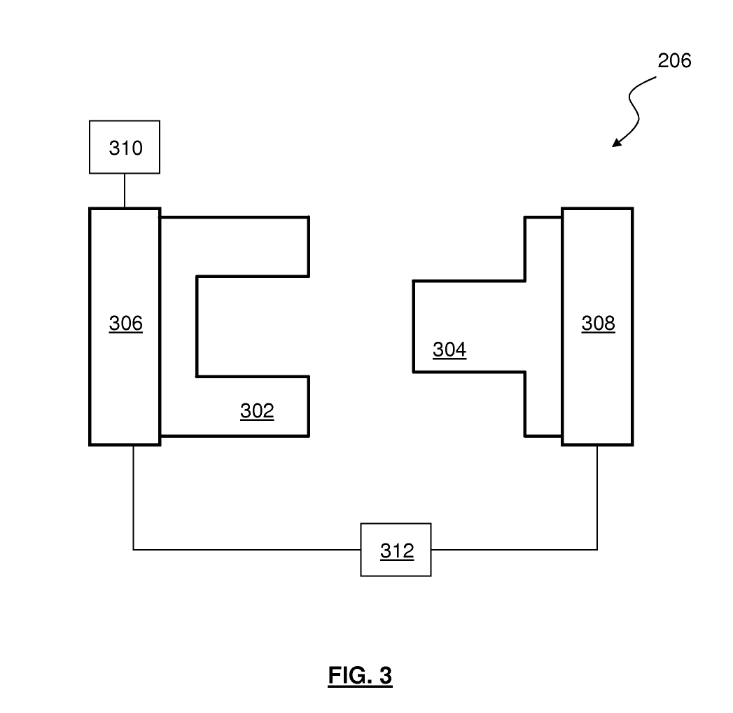

With further reference to FIG. 3, a non-limiting embodiment of the forming station 206 will now be described in greater detail. In this specific non-limiting embodiment of the present invention, the forming station 206 comprises a female cavity 302 and a male mandrel 304. The male mandrel 304 is associated with a dimension substantially complementary to the female cavity 302 such that the male mandrel 304 and the female cavity 302 together define, in use, a shape that corresponds to a shape of the article that is to be produced using the manufacturing system 200. The female cavity 302 is associated with a mounting plate 306 and the male mandrel 304 is associated with a mounting plate 308. In some embodiments of the present invention, at least one of the mounting plate 306 and the mounting plate 308 can comprise a clamping mechanism (not separately numbered) to provide, in use, a clamping force to keep the female cavity 302 and the male mandrel 304 in a locked position. In other embodiments of the present invention, at least one of the mounting plate 306 and the mounting plate 308 can comprise an actuating mechanism (not separately numbered) to actuate, in use, the female cavity 302 and the male mandrel 304 towards and away relative to each other.

In some embodiments of the present invention the female cavity 302 can be further associated with temperature means 310. In some embodiments of the present invention, the temperature means 310 can be used to cool the female cavity 302. In alternative non-limiting embodiments of the present invention, which are particularly applicable where the heating station 204 and the forming station 206 are implemented as the above-mentioned single device 205, the temperature means 310 can be used to heat and to cool the female cavity 302. How the temperature means 310 are implemented are not particularly limited and can comprise one or more of: a combined cooling/heating unit, a separate cooling and a separate heating unit, etc. Any suitable type of cooling medium and heating medium known to those skilled in the art can be used.

The forming station 206 can further comprise a forming station controller 312. The forming station controller 312 can be implemented as a general purpose or a special purpose computing device. Generally speaking, the purpose of the forming station controller 312 is to control operation of various components of the forming station 206. Examples of routines that can be executed by the forming station controller 312 include: (a) opening and closing the female cavity 302 and the male mandrel 304; (b) applying force by using the mounting plate 306 and/or the mounting plate 308; (c) controlling cooling rates; and (d) optionally controlling heat emitted by the heating means 310. Naturally, the forming station controller 312 can be configured to implement a number of similar or alternative routines.

Returning to the description of FIG. 2, in some embodiments of the present invention, the article outputted by the forming station 206 can substantially correspond to the desired end-article dimensions. Within this scenario, the article produced by the forming station 206 is referred to by those of skill in the art as a “net shape article”. However, in alternative non-limiting embodiments of the present invention, the article produced by the forming station 206 can be substantially close to the desired end-article dimensions. In this scenario, the article produced by the forming station 206 can be referred to as a “near-net shape article” or, alternatively, as an “intermediate article”. Within some of these embodiments of the present invention, the manufacturing system 200 can further comprise the machining station 208. The purpose of the machining station 208 can be to perform finish machining of the near-net shape article produced by the forming station 206 into the net shape article. It is worthwhile noting that even though the machining station 208 can be present within the manufacturing system 200, it does not have to be as complex as the prior art machining equipment. Alternatively or additionally, the time required to precise-machine the near-net shape article into the net shape article is comparatively less then with prior art approaches as comparatively less material is being removed.

In some embodiments of the present invention, the manufacturing system 200 can further comprise a manufacturing system controller 210. The manufacturing system controller 210 can be implemented as a general purpose or a special purpose computing device. Generally speaking, the purpose of the manufacturing system controller 210 is to control some or all of the components of the manufacturing system 200. Examples of routines that can be executed by the manufacturing system controller 210 include: (a) tracking inventory level of raw material maintained by the material source 202; (b) controlling temperature of the heating station 204; (c) controlling forming station 206 and, more specifically, controlling the forming station controller 312. Naturally, the manufacturing system controller 210 can be configured to implement a number of similar or alternative routines. The manufacturing system controller 212 is coupled to one or more of the other components of the manufacturing system 200 via a control link 212. In some embodiments of the present invention, the control link 212 can be implemented as a wired connection. In alternative embodiments of the present invention, the control link 212 can be implemented as a wireless connection. Examples of wireless communication protocols that can be used include, but are not limited to, WI-FI, BLUETOOTH, WI-MAX and the like

In alternative non-limiting embodiments of the present invention, the manufacturing system controller 210 and the forming station controller 312 can be implemented as a single entity. In alternative non-limiting embodiments of the present invention, some or all of the routines implemented by the manufacturing system controller 210 and/or the forming station controller 312 may be implemented in a distributed manner, i.e. by one or more computing apparatuses. In yet further non-limiting embodiments of the present invention, the manufacturing system controller 210 and/or the forming station controller 312 can be omitted altogether.

Operation of the manufacturing system 200 within context of producing a molding system component will now be described in greater detail. More specifically, given the architecture described above with reference to FIG. 2 and FIG. 3, it is possible to implement a method for producing a molding system component according to a non-limiting embodiment of the present invention.

First, a metallic work piece heated to a re-moldable state is disposed within the female cavity 302. In some embodiments of the present invention, the raw material from the material source 202 is first heated in the heating station 204 and then disposed in the forming station 206. In other embodiments of the present invention, which are particularly applicable where the heating station 204 and the forming station 206 are implemented in the above-mentioned single device 205; the raw material from the material source 202 is disposed in the forming station 206 and then heated to the re-moldable state.

Then, the so-heated metallic work piece is impacted with the male mandrel 304 to form an article (i.e. a molding system component to be used in the molding system 100 and the like), at least in part, between the female cavity 302 and the male mandrel 304. For example, under control of the manufacturing system controller 210, the mounting plate 306 and/or the mounting plate 308 are urged towards each other and are held in the operating position by the clamping force, for example.

The so-formed article is then cooled to a temperature sufficient to allow for removal of the so-formed article. For example, under control of the forming station controller 312 and using the temperature means 310, the so-formed article is cooled to the required temperature.

Once the required temperature is achieved, the so-formed article is then removed. For example, under control of the manufacturing system controller 210, the mounting plate 306 and/or the mounting plate 308 are urged apart from each other. The so-formed article can then be removed either manually by an operator or using a known article removal means, such as ejector pins or an appropriate part removal device (such as a robot and the like).

Description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A method for manufacturing a molding system component having a tubular configuration, at least in part, the molding system component for use with a molding system, the method comprising:
disposing a metallic work piece heated to a re-moldable state within a female cavity of a forming station;
impacting the heated metallic work piece with a male mandrel of the forming station to form the molding system component between the female cavity and the male mandrel, at least partially;
cooling the so-formed molding system component.

2. The method of claim 1, wherein said disposing comprises receiving the metallic work piece that has been heated to the re-moldable state in a heating station.

3. The method of claim 1, wherein said disposing comprises placing raw material into a forming station and heating the so-placed raw material to the re-moldable state.

4. The method of claim 1, wherein the so-formed molding system component comprises a net-shape article.

5. The method of claim 1, wherein the so-formed molding system component comprises a near net-shape article, and wherein the method further comprises finish machining the molding system component from the near net-shape article to a net shape article.

6. The method of claim 1, further comprising ejecting the so-formed molding system component from the forming station.

7. The method of claim 1, wherein the molding system component comprises a hot runner nozzle housing.

8. The method of claim 1, wherein the molding system component comprises a molded article holder for use with an end of arm tool.

9. The method of claim 1, wherein the molding system component comprises a mold cavity insert body.

10. A manufacturing system for manufacturing a molding system component having a tubular configuration, at least in part, the molding system component for use with a molding system, the manufacturing system comprising:
a forming station configured to impact a heated metallic work piece with a male mandrel to form the molding system component between a female cavity and the male mandrel, at least partially.

11. The manufacturing system of claim 10, wherein the forming station is further configured to cool the so-formed molding system component.

12. The manufacturing system of claim 11, where the forming station is further configured to eject the so-cooled molding system component.
The manufacturing system of claim 11, further comprising a heating station configured to heat the metallic work piece to a re-moldable state;

13. The manufacturing system of claim 12, wherein said heating station and said forming station are implemented in a single device.

14. The manufacturing system of claim 10, wherein said forming station is further configured to heat said metallic work piece to the re-moldable state.

15. The manufacturing system of claim 10, further comprising a material source configured to maintain a supply of raw material to be used within the heating station.

16. The manufacturing system of claim 10, wherein the so-formed molded system component comprises a net-shape article.

17. The manufacturing system of claim 10, wherein the so-formed molding system component comprises a near net-shape article, and wherein the manufacturing system further comprising a machining station configured to finish machine the molding system component from the near net-shape article to a net shape article.

18. The manufacturing system of claim 10, further comprising a manufacturing system controller configured to control at least one component of the manufacturing system.

19. An apparatus for manufacturing a molding system component having a tubular configuration, at least in part, the molding system component for use with a molding system, the apparatus comprising:
means for heating a metallic work piece to a re-moldable state;
means for impacting the metallic work piece to form the molding system component;
means for cooling the so-formed molding system component.

20. The apparatus of claim 19, further comprising means for removing the so-formed molding system component.

21. The apparatus of claim 19, further comprising means for controlling operation of at least one of said means for heating, said means for impacting and said means for cooling.
